(19) United States
(12) Patent Application Publication
(10) Pub. No.: US 2008/0010504 A1
(43) Pub. Date: Jan. 10, 2008

(54) Method and apparatus for storing data in a disk drive with nonvolatile memory

(75) Inventor: Yasuichi Hashimoto, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/798,406

(22) Filed: May 14, 2007

(30) Foreign Application Priority Data
Jun. 7, 2006 (JP) 2006-158831

(51) Int. Cl. G06F 11/00

(52) U.S. Cl. 714/6

(57) ABSTRACT

According to one embodiment, a magnetic disc device includes a disk medium to magnetically record data and a nonvolatile memory storing a program for manufacture thereon and capable of rewriting data. After completing running of the program for manufacture, a microprocessor uses the data recording area on the nonvolatile memory as a data recording area of the magnetic disk device together with the data recording area of the disk medium.

### CROSS-REFERENCE TO RELATED APPLICATIONS

This application is based upon and claims the benefit of priority from Japanese Patent Application No. 2006-158831, filed Jun. 7, 2006, the entire contents of which are incorporated herein by reference.

### BACKGROUND

1. Field

One embodiment of the invention relates to a disk drive, and more specifically, relates to a disk drive having a nonvolatile memory with a large capacity.

2. Description of the Related Art

In general, a disk drive is an information recording and reproducing device which magnetically records data on a discoid disk medium and reproduces the recorded data from the disk medium.

The disk drive includes a head to record and reproduce the data on and from the disk medium; and a head disk assembly including an actuator to move the head up to a targeted track on the disk medium to fix the position of the head. On the disk medium, a large number of recording tracks are structured in a concentric circle shape as data recording areas.

In recent years, a nonvolatile semiconductor memory called a flash EEPROM, etc., (hereinafter, simply referred to as a nonvolatile memory) has become large in capacity and cheap in price. A disk drive having such a nonvolatile memory with a large capacity built-in, and using the nonvolatile memory as a part of data recording area together with a disk medium has been suggested (for example, Jpn. Pat. Appln. KOKAI Publication No. 2004-5778).

In these years, the disk drive having increased the number of recording tracks on the disk medium as recording density improves, especially; servo control to fix the position of the head at the targeted track needs to record servo data with high precision on the disk medium. A servo data writing process of recording such servo data, and a check process of checking the recorded servo data requires a dedicated servo writing device and a checking device, and also these processes need long times among manufacturing processes of the disk drive.

To improve efficiency in manufacturing the disk drive, a system capable of executing a part of the manufacturing process including such a servo data writing process by the disk drive itself is preferable. However, a memory to store a large-scaled program for manufacture therein is necessary for executing a part of the manufacturing process by the disk drive itself.

The disk drive having the aforementioned large capacity nonvolatile memory built-in mainly uses the nonvolatile memory as a data recording area for user data, and does not have a function to store the program for manufacture and execute a part of the manufacturing process by the disk drive itself.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a main part of a disk drive relating to an embodiment of the present invention;

FIGS. 2A to 2C are exemplary views respectively depicting appearances of the disk drives relating to the embodiments;

FIG. 3 is an exemplary block diagram for explaining a main part of a control system of the disk drive relating to the embodiment;

FIG. 4 is an exemplary view for explaining a configuration of data recording areas of the disk drive relating to the embodiment;

FIG. 5 is an exemplary flowchart for explaining a procedure including manufacturing processes of the disk drive relating to the embodiment;

FIG. 6 is an exemplary flowchart for explaining a concrete procedure of the manufacturing processes of the disk drive relating to the embodiment;

FIG. 7 is an exemplary flowchart for explaining a procedure of writing operations of the disk drive relating to the embodiment; and

FIG. 8 is an exemplary flowchart for explaining a procedure of reading operations of the disk drive relating to the embodiment.

### DETAILED DESCRIPTION

Various embodiments according to the invention will be described hereinafter with reference to the accompanying drawings. In general, according to one embodiment of the invention, there is provided a disk drive which has a function of especially utilizing a large capacity nonvolatile memory to execute a part of manufacturing process by a disk drive itself, and also a function of enabling the use of the nonvolatile memory as a data recording area after completing the manufacturing process.

(Configuration of Disk Drive)

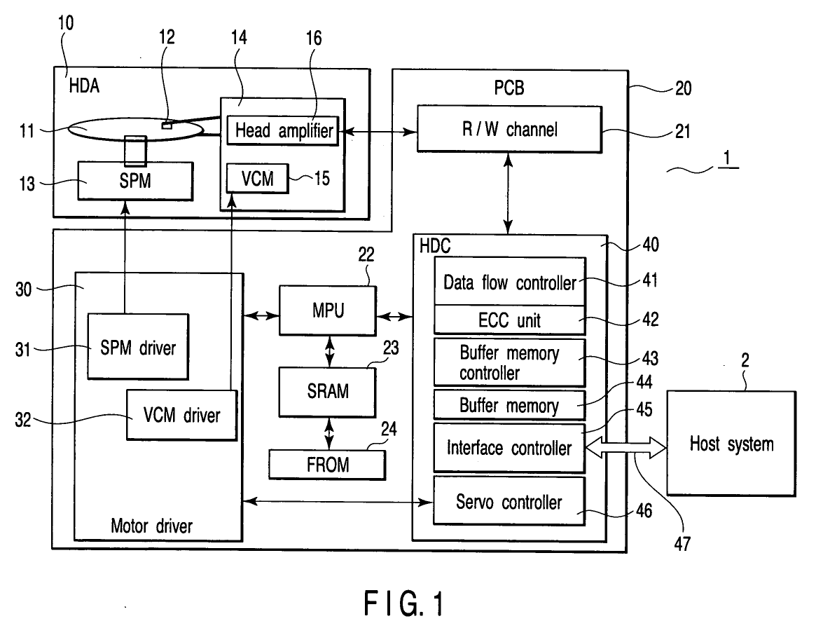

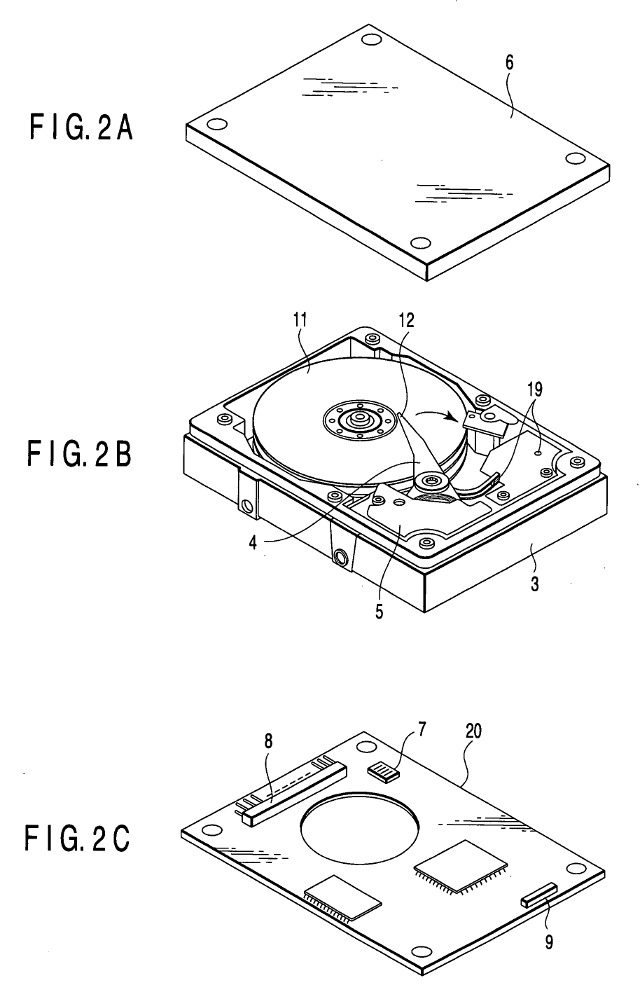

FIG. 1 is a block diagram illustrating a main part of a currently generic disk drive. FIGS. 2A to 2C are respective views illustrating appearances of the disk drives.

Each mechanism of a disk drive 1, as respectively shown in FIGS. 2A to 2B, is accommodated in a disk enclosure shielded by a pedestal 3 and a top cover 6. The disk drive 1, as shown in FIG. 1, mainly composed of a head disk assembly (HDA) 10 including a disk medium 11 and a head 12, and a printed circuit board (PCB) 20 with a variety of circuit components constituting a control circuit system mounted thereon.

The HDA 10 includes a spindle motor (SPM) 13 rotating the disk medium 11, and an actuator 14 mounting the head thereon to move it in the radius direction of the disk medium 11. The actuator 14 has a voice coil motor (VCM) 15 composed of a head arm 4 mounting the head 12 thereon, a magnet 5, and the like (refer to FIG. 1 and FIG. 2B).

The head 12 has a read head element and a write head element. The head 12 is electrically connected to a flexible printed circuit board (FPC) 19, and connected to a head amplifier 16 mounted on the corresponding FPC 19. The HDA 10 being shielded, it aerates to outside only though a breathing filter (not shown).

The PCB 20 is, as shown in FIG. 2C, fixed to the lower part of the pedestal 3, and mounts components, such as a connector 7 to supply a drive signal to the SPM 13, a connector 8 to be connected to the host system 2, and a connector 9 to be connected to the HDA 10, thereon. The connector 9 transmits and receives a head control signal and a VCM control signal mentioned below.

Further, functions of the disk drive 1 will be set forth with reference to FIG. 1.

The actuator 14 of the HDA 10 is also called a carriage, rotates around a fixed shaft by a drive force from the VCM 15, and moves the head 12 in the radius direction of the disk medium 11. The VCM 15 is controlled its driving by a drive current supplied from a VCM driver 32 included in a motor driver 30 mounted on the PCB 20. The motor driver 30 includes the VCM driver 32 and a SPM driver 31. The SPM driver 31 controls its driving of the SPM 13 which rotates the disk medium 11.

The PCB 20 mounts a read/write (R/W) channel 21, a microprocessor (MPU) 22, a program memory (static RAM [SRAM]) 23, a nonvolatile memory (FROM) 24, and a hard disk controller (HDC) 40 thereon other than the motor driver 30.

A control program to be run by the MPU 22 is stored in the FROM 24, and in general, when the power of the disk drive is turned on, the control program is appropriately transferred to the SRAM 23 to be executed at high speed.

The R/W channel 21 is a circuit to conduct signal processing of recorded data and reproduced data. More specifically, the R/W channel 21 outputs the recorded data according to a recording format together with a writing control signal. The R/W channel 21 receives an analog reproduced signal from the head amplifier 16 and converts (decodes) it into digital reproduced data to output it. Further, the R/W channel 21 includes a servo information reproducing function of reproducing servo information from servo data read by the head 12, and outputs the reproduced servo information. The servo data is recorded in a servo area on the disk medium 11 though a servo data writing process mentioned below.

The HDC 40 achieves a function to control data transfer mainly between the disk drive 1 and the host system 2. Specifically, the HDC 40 includes a data flow controller 41, an error correction unit (ECC unit) 42, a buffer memory controller 43, a buffer memory 44, an interface controller 45, and a servo controller 46.

The data flow controller 41 controls data transfer between the R/W channel 21 and the interface controller 45 via the buffer memory 44 through the control by the MPU 22. The ECC unit 42 executes error correction processing of the reproduced data output from the R/W channel 21.

The buffer memory controller 43 controls writing operations or reading operations of the data in the buffer memory 44 through the control by the data flow controller 41. The interface controller 45 controls the data transfer between the disk drive 1 and the host system 2 via an interface line 47. The servo controller 46 controls the VCM driver 32 included in the motor driver 30 to execute the servo control operations for positioning the head 12 at the targeted track on the disk medium 11.

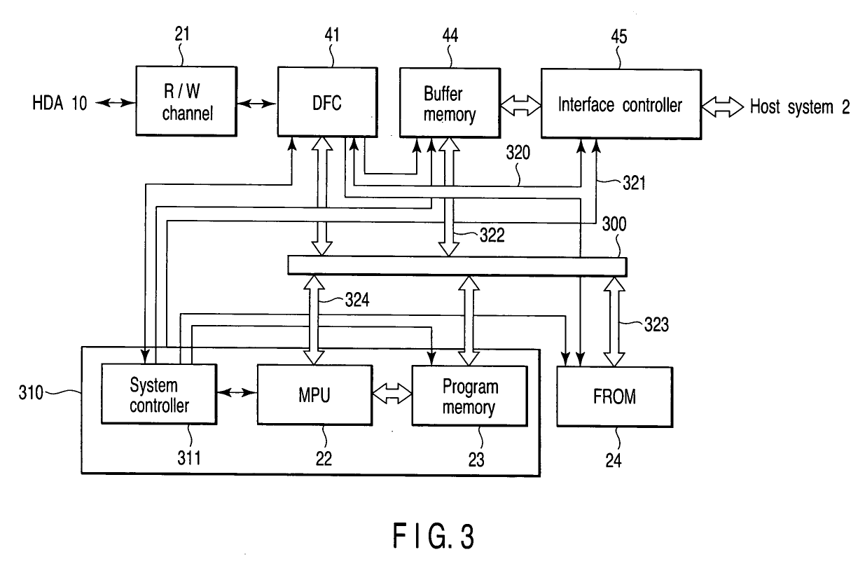

FIG. 3 is a block diagram for explaining a concrete configuration of the PCB 20 in the disk drive 1 of FIG. 1.

The configuration shown in FIG. 3 is different from that of FIG. 1 in that the FROM 24 is not connected to only the MPU 22 and the SRAM 27, but also connected to the buffer memory 44.

The MPU 22 and the program memory (SRAM) 23 are, as shown in FIG. 3, constituent elements included in a processor unit 310. The processor unit 310 includes a system controller 311 to process a control signal for controlling operations of each element, etc., of the HDC 40. The MPU 22 is a main control element, and controls a part of the manufacturing process and operations of the disk drive 1 related to the embodiment of the invention by executing the program stored in the program memory 23.

The FROM 24 is a nonvolatile semiconductor memory with a relatively large capacity, and as mentioned below, a program for manufacture, a control program, and a master program to execute a part of the manufacture process of the disk drive 1 by the disk drive 1 itself are stored therein before installing into the disk drive 1. The FROM 24 is, as described later, used as a user data recording area which continues to the user data recording area on the disk medium 11.

(Operation of Embodiment)

Hereinafter, the operation of the embodiment will be described by referring to FIG. 3 to FIG. 8.

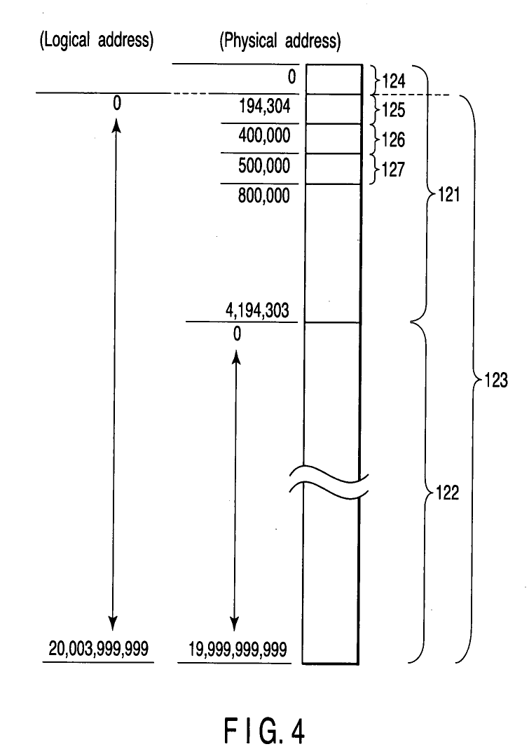

At first, the disk drive 1 of the embodiment has, as shown in FIG. 4, a data recording area (123) of, for instance, 20 gigabytes (GB) that is an area formed by putting each data recording area of the disk medium 11 and the FROM 24 together as a data recording area accessible from the host system 2. That is, as mentioned below, the data recording area (123) is assigned logical addresses continuous from a logical address “0” so that the host system 2 is accessible thereto. Here, the FROM 24 is presumed that has a capacity of, for example, 4,194,304 bytes as the data recording area (121).

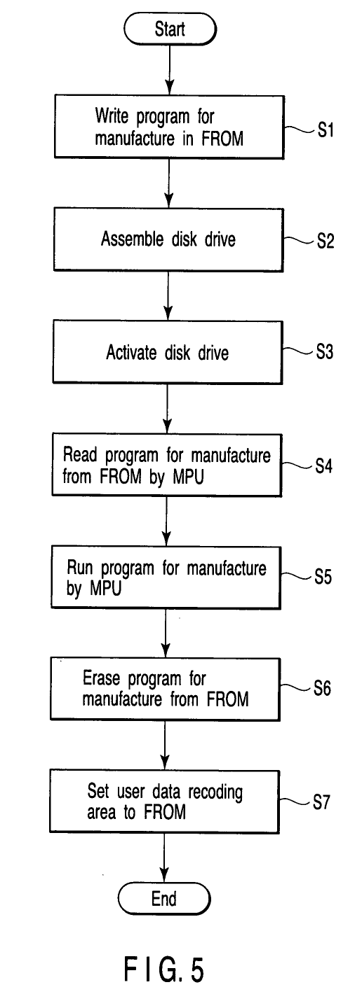

As to the operation of the embodiment, a procedure from a manufacture process for the disk drive 1 will be described with reference to the flowchart in FIG. 5.

Firstly, a manufacture process before assembling the disk drive 1 writes the program for manufacture, the control program, and the master program to the FROM 24 (block S1).

Here, as shown in FIG. 4, the control program and the master program are written into a recoding area (124) at the top of the FROM 24. A program for servo data writing included in the program for manufacture is written into a recording area (125) on the FROM 24. A program for servo data check included in the program for manufacture is written into a recording area (126) of the FROM 24. Moreover, a program for check included in the program for manufacture is written into a recording area (127) of the FROM 24.

Next, the procedure mounts the HDA 10, the PCB 20, etc., onto the pedestal 3 of the disk drive 1 to proceed with an assembly process of the disk drive 1 (block S2). After completing the assembly, the disk drive 1 is turned on and activated (block S3).

When the disk drive 1 is activated, the MPU 22 reads to execute the master program from the preset and specified address of the FROM 24 (physical address included in recording area 124) (block S4). More specifically, as shown in FIG. 3, the system controller 311 controls so as to store the master program read from the FROM 24 in the program memory 23. The MPU 22 runs the master program stored in the program memory 23.

The master program has program running control information (hereinafter, simply referred to as running control information) to control the running of other programs, and instructs programs to be preferentially executed in accordance with the running control information. The MPU 22 runs the program for manufacture to execute a part of manufacture process depending on the running control information (block S5).

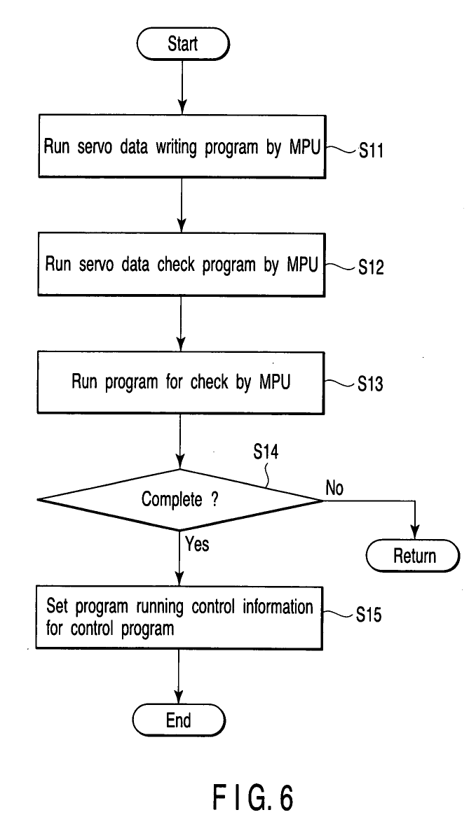

That is to say, as shown in FIG. 6, the MPU 22 firstly runs the program for writing servo data (block S11). Next, the MPU 22 runs servo data check program (block S12). The MPU 22 then runs a program for check (block S13). After completing the running of the program for manufacture, on supplying power after this, the master program rewrites the running control information so that only the control program is executed (YES in blocks S14 and S15). Thereby, in the disk drive to be shipped, after the power on, the MPU 22 runs the control program read from the FROM 24, and as described later, it executes normal operation of the disk drive 1.

When completing the running of the program for manufacture, and completing the execution of a part of manufacture process such as a servo data writing process, the MPU 22 erases the program for manufacture from the FROM 24 (block S6 in FIG. 5). As shown in FIG. 4, each program which has been stored in the recording areas 125, 126 and 127 of the FROM 24 is erased therefrom, and the recording areas 125 to 127 become usable as the data recording areas.

The MPU 22 sets those recording areas 125 to 127 as the host system 2-accessible data recording areas of the disk drive except the recording area 124 with the master program and the control program of the FROM 24 recorded therein (block S7 in FIG. 5). More specifically, the MPU 22 assigns the logical addresses which continue from the logical address “0” to the data recording area 123 that is an area made by putting each data recording area of the disk medium 11 and the FROM 24 together as the host system 2-accessible data recording area.

(Normal Operation of Disk Drive)

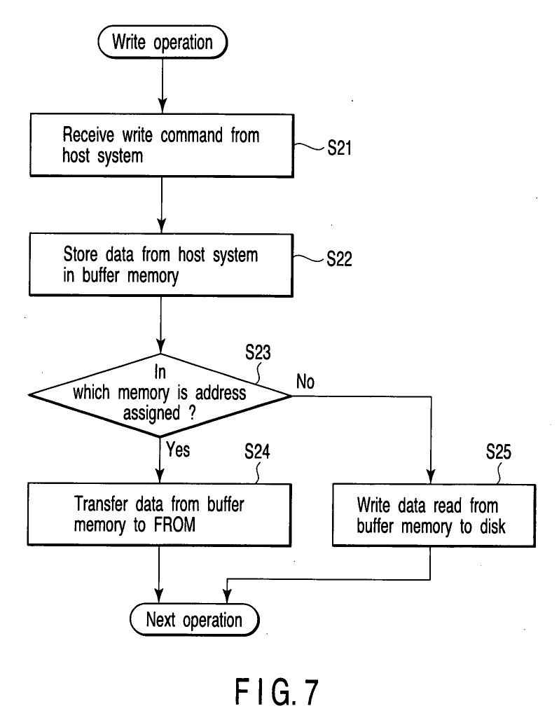

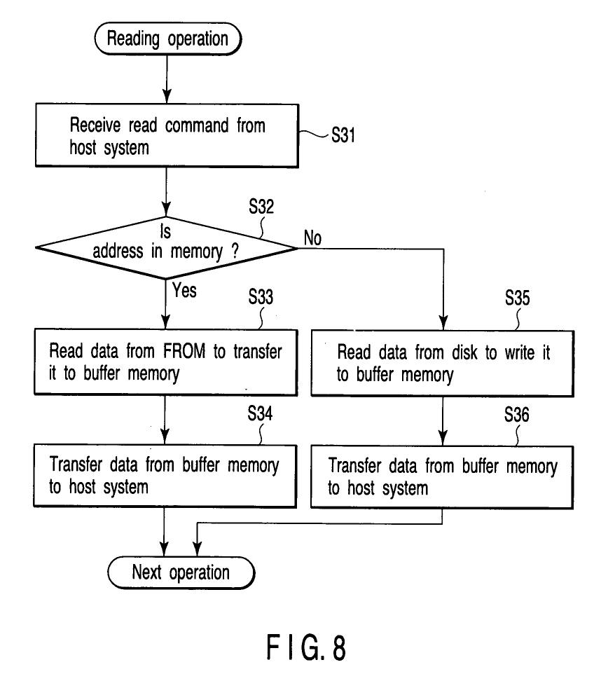

Next to this, normal operation of the disk drive will be described by referring to the flowcharts of FIG. 7 and FIG. 8 together with FIG. 3.

As mentioned above, in the disk drive 1 to be shipped, the MPU 22 runs the control program read from the FROM 24 after the power is turned on, and executes normal operations of the disk drive 1 as given below.

At first, as shown in FIG. 7, in a writing operation, on being sent a write command from the host system 2, the interface controller 45 notifies the fact to a processor unit 310 and a data flow controller (DFC) 41 via signal lines 320 and 321 (block S21). Subsequently, the interface controller 45 starts receiving the data (write data) transferred from the host system 2.

A system controller 311 of the processor unit 310 sets a buffer address in order to store the data in the buffer memory 44. The DFC 41 sequentially stores the data transferred from the host system 2 in the buffer memory 44 (block S22).

The MPU 22 determines in which range of the recording area on the disk medium 11 or the FROM 24 the recording addresses (logical addresses) included in the write command from the host system 2 is assigned (block S23). If the recording addresses are assigned within the recording area of the FROM 24, the DFC 41 transfers the data stored in the buffer memory 44 from the buffer memory 44 to the FROM 24 in accordance with the control by the system controller 311 (YES in blocks S23 and S24). The DFC 41 transfers the data from the buffer memory 44 to the FROM 24 via data buses 300, 322, 323.

In contrast, if the recording addresses are assigned within the recording area on the disk medium 11, the MPU 22 positions the head 12 on the objected track (physical address corresponding to recording address) on the disk medium 11 through the servo controller 46 and instructs the DFC 41 to write data.

The DFC 41 sequentially reads the data stored in the buffer memory 44 to transfer it to the R/W channel 21 (NO in blocks S23 and S25). Thereby, the head 12 writes the data in the targeted physical address on the disk medium 11 by means of a write head element in accordance with the write signal transmitted from the R/W channel 21.

As given above, the disk drive 1 records the data at the logical addresses specified by the host system 2 in the data recording area 123 that is an area formed by bringing each data recording area on the disk medium 11 and the FROM 24 together. Therefore, the host system 2 may select any one of the disk medium 11 or the FROM 24 as the data recording area by specifying the logical addresses to record the data. For example, when the host system 2 needs to access data at a high rate from the FROM 24 for reproduction of motion, the host system 2 thereby can record the data in the FROM 24. In contrast, the host system 2 can record the data to be stored only a fixed while with a large amount in the disk medium 11.

Next, as shown in FIG. 8, in a reading operation, on being sent a read command from the host system 2, the interface controller 45 notifies the fact to the processor unit 310 and the DFC 41 via the signal lines 320 and 321 to start the reading operation of the data (block S31).

The MPU 22 determines in which range of the recording area on the disk medium 11 or the FROM 24 the reproduction addresses (logical addresses) included in the read command from the host system 2 are assigned (block S32).

If the reproduction addresses are assigned within the range of the recording area on the FROM 24, the DFC 41 reads the data from the FROM 24 via data buses 300, 322 and 323 in accordance with the control by the system controller 311 to transfer it to the buffer memory 44 (YES in blocks S32 and S33). The DFC 41 transfers the data stored in the buffer memory 44 to the host system 2 through the interface controller 45 (block S34).

In contrast, if the reproduction addresses are assigned within the range of the recording area on the disk medium 11, the MPU 22 positions the head 12 at the objected track (physical addresses corresponding to reproduction addresses) on the disk medium 11 and instructs the DFC 41 to read the data.

The DFC 41 aligns the data read from the disk medium 11 through the read head element of the head 12 and the R/W channel 21 to write it to the buffer memory 44 (block S35). Further, after executing the error correction processing by the ECC unit 42 of the HDC 40, the DFC 41 takes out the data from the buffer memory 44 to transfer it to the host system 2 via the interface controller 45 (block S36).

As mentioned above, the disk drive 1 reproduces the recorded data from the logical addresses specified by the host system 2 in the data recording area 123 that is the area as the sum of each data recording area of the disk medium 11 and the FROM 24. Accordingly, the host system 2 may select any one of the disk medium 11 or the FROM 24 as the data recording area by specifying the logical addresses to reproduce the recorded data recorded in the data recording area. Thereby, the host system 2 may record the data necessary for, for example, reproduction of motion images in the FROM 24 in advance, and may access at a high rate to reproduce it from the FROM 24 for reproducing. In addition, the host system 2 may record the data to be stored only for a fixed while with a large amount in the disk medium 11, and may read it from the disk medium 11 if necessary.

In the embodiment, the MPU 22 may directly access the FROM 24 via the data buses 300, 323 and 324 to read and write the data arbitrarily. As a matter of course, the MPU 22 may read and write once the data from and to the FROM 24 through the buffer memory 44 or the program memory 23.

Further, the embodiment having described about the case in which the program for manufacture is erased after completing its running, if the storage capacity of the FROM 24 is large; it is not always needed to erase the program for manufacture. However, even when the program for manufacture is left, it is preferable to disable it so as not to be run after the completion of the running.

According to the embodiment, the magnetic disk device having the function to execute a part of the manufacturing process by the disk drive itself by especially using the nonvolatile memory with a large capacity, and also to enable using the nonvolatile memory as the data recording area after completing the manufacturing process.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a disk medium to magnetically record data;
a mechanism to record and reproduce the data on and from the disk medium;
a nonvolatile memory rewritable data and which stores a program for manufacture;
a buffer memory which stores the data to be transferred between the disk medium or the nonvolatile memory and a host system;
a unit which runs the program for manufacture read from the nonvolatile memory; and
a unit which uses the recording area of the nonvolatile memory as a data recording area to record the data transferred from the host system after completing the running of the program for manufacture; and
a unit which selects any one of data recording areas on the disk medium or the nonvolatile memory, records the data transferred from the host system, or reproduces the data from the selected data recording area to transfer the data to the host system.

2. The disk drive according to claim 1, wherein after completing the running of the program for manufacture, in a whole of recording areas of the nonvolatile memory, a part of or the whole of the recording areas, including a recording area in which the program for manufacture has been stored, is used as a data recording are to record the data transferred from the host system.

3. The disk drive according to claim 1, further comprising:
unit for assigning addresses, which continues from addresses assigned to the data recording area on the disk medium, to the data recording area on the disk medium.

4. The disk drive according to claim 1, further comprising:
unit capable of arbitrarily setting addresses to assign to the data recording area on the disk medium, and addresses to assign to the data recording area on the nonvolatile memory.

5. The disk drive according to claim 1, wherein the nonvolatile memory stores a control program to execute recording and reproducing control together with the program for manufacture, and includes program control unit for controlling so as to start running of the program for manufacture and to enable running the control program after completing the running of the program for manufacture in accordance with program running control information.

6. The disk drive according to claim 1, wherein the program for manufacture includes a program which achieves any one of or a whole of functions to execute a variety of tests or checks, to write servo data to the disk medium, or to check the servo data recorded on the disk medium.

7. The disk drive according to claim 5, wherein the program for manufacture includes a program which achieves any one of or a whole of functions to execute a variety of tests or checks, to write servo data to the disk medium, or to check the servo data recorded on the disk medium.

8. The disk drive according to claim 1, further comprising:
a microprocessor as a part of means for running the program for manufacture, and of means for executing the recording and reproducing control, wherein the nonvolatile memory stores a control program to execute the recording and reproducing control together with the program for manufacture and program running control information to control the running of the programs; and
the microprocessor runs the program for manufacture in accordance with the program running control information, and runs the control program in accordance with the rewritten program running control information rewritten after completing the running of the program for manufacture.

9. The disk drive according to claim 8, wherein the program for manufacture includes a program which achieves any one of or a whole of functions to execute a variety of tests or checks, to write servo data to the disk medium, or to check the servo data recorded on the disk medium.

10. The disk drive according to claim 1, further comprising:
a microprocessor as a apart of means for running the program for manufacture, and of means for executing the recording and reproducing control, wherein
the nonvolatile memory stores a control program to execute the recording and reproducing control and a master program to control running of the programs together with the program for manufacture;
the microprocessor runs the program for manufacture in accordance with program running control information by running the master program stored at a specified address on the nonvolatile memory when power is turned on, rewrites the program running control information after completing the running of the program for manufacture by running the master program, and runs the control program in accordance with the rewritten program running control information.

11. The disk drive according to claim 1, further comprising:
an interface controller to control transfer of the data between the host system and the buffer memory, wherein
the unit which executes the recording and reproducing control receives the data transferred from the host system by the interface controller to store the data in the buffer memory in recording the data, executes control of writing of the data stored in the buffer memory into the data recording area on the nonvolatile memory, based on information specified by the host system, reads the recorded data from the data recording area on the nonvolatile memory in accordance with addresses specified by the host system, and stores the read recorded data in the buffer memory so as to transfer the recorded data to the host system by the interface controller.

12. A method of recording data, which is applied to a magnetic disc device having a disk medium to magnetically record data and having a nonvolatile memory storing a program for manufacture and enabling data rewriting, the method comprising:
running the program for manufacture read from the nonvolatile memory in activating the magnetic disk device; and
using a recording area on the nonvolatile memory as a data recording area which can be used by selecting the recording areas on the nonvolatile memory and on the disk medium in recording data transferred from a host system after completing the running of the program for manufacture.

13. The method according to claim 12, further comprising:
using a part of or a whole of recording areas, including a recording area in which the program for manufacture has been stored, as a data recording area to record the data transferred from the host system, in the whole of the recording areas on the nonvolatile memory after completing the running of the program for manufacture.

14. The method according to claim 12, further comprising:
controlling the nonvolatile memory so as to store a control program to execute recoding control of the data together with the program for manufacture, and to enable running the control program after completing the running of the program for manufacture.

15. The disk drive according to claim 1, wherein the whole or a part of the nonvolatile memory is used as the cache memory for the recording area on the disk medium.

16. The method according to claim 12, wherein the whole or a part of the nonvolatile memory is used as the cache memory for the recording area on the disk medium.
